(19) United States
(12) Patent Application Publication
(10) Pub. No.: US 2026/0029691 A1
(43) Pub. Date: Jan. 29, 2026

(54) NECK-HANGING SELFIE PHOTOGRAPHY SUPPORT DEVICE

(71) Applicant: Dongguan Winking Technology Co.,Ltd, Dongguan (CN)

(72) Inventor: Zhixuan LI, Dongguan (CN)

(73) Assignee: Dongguan Winking Technology Co.,Ltd, Dongguan, GD (CN)

(21) Appl. No.: 18/815,821

(22) Filed: Aug. 26, 2024

(30) Foreign Application Priority Data
Jul. 25, 2024 (CN) 2024217731963
Jul. 25, 2024 (CN) 2024217735714

(51) Int. Cl. G03B 17/56; F16M 11/04; F16M 13/04

(52) U.S. Cl. CPC G03B 17/561; F16M 11/04; F16M 13/04

(57) ABSTRACT

Disclosed is a neck-hanging selfie photography support device, including a neck-buckling body. An equipment holder, a flexible first neck-surrounding part and a flexible second neck-surrounding part are arranged on the neck-buckling body. In a neck-hanging state, the first neck-surrounding part and the second neck-surrounding part are detachably fixed, and a neck-hanging space is formed by enclosing the first neck-surrounding part and the second neck-surrounding part. In a selfie state, the first neck-surrounding part and the second neck-surrounding part bend towards each other until the first neck-surrounding part and the second neck-surrounding part are arranged side by side, and the first neck-surrounding part and the second neck-surrounding part collectively form a support rod structure. The neck-hanging selfie photography support device is capable of switching between the neck-hanging state and the selfie state, and better meeting users' photography needs.

### TECHNICAL FIELD

The present disclosure relates to the technical field of photography supports, and particularly relates to a neck-hanging selfie photography support device.

### BACKGROUND

A neck-hanging selfie photography support can be hung around a user's neck, and a mounting bracket on the neck-hanging selfie photography support is used to mount photographic equipment or terminal equipment with cameras such as a mobile phone, which facilitates the carrying and operation of photographic equipment during shooting.

A neck-hanging selfie photography support in the prior art usually is hung around the user's neck through a strap. However, when the user is wearing headwear, a hat and any other headpiece, these ornaments may affect the placement of the strap. When the user wears glasses, the glasses are prone to falling off due to collision by the strap.

### SUMMARY

In order to overcome the defects in the prior art, an objective of the present disclosure is to provide a neck-hanging selfie photography support device.

In an embodiment of the present disclosure, there is provided a neck-hanging selfie photography support device, and the neck-hanging selfie photography support device includes a neck-buckling body;

an equipment holder, a flexible first neck-surrounding part and a flexible second neck-surrounding part are arranged on the neck-buckling body;

in a neck-hanging state, an end portion of the first neck-surrounding part and an end portion of the second neck-surrounding part are detachably fixed through a buckle structure or a magnetic attraction structure, the first neck-surrounding part and the second neck-surrounding part bend away from each other, and a neck-hanging space is formed by enclosing the first neck-surrounding part and the second neck-surrounding part; and

in a selfie state, the end portion of the first neck-surrounding part and the end portion of the second neck-surrounding part are separated from each other, the first neck-surrounding part and the second neck-surrounding part bend towards each other until the first neck-surrounding part and the second neck-surrounding part are arranged side by side, and the first neck-surrounding part and the second neck-surrounding part collectively form a support rod structure.

In some optional implementations, an end portion of the first neck-surrounding part is provided with a first magnetic element and a buckling piece, and an end portion of the second neck-surrounding part is provided with a second magnetic element and a buckling groove; and

in the neck-hanging state, the first magnetic element and the second magnetic element match each other in a magnetic manner, and the buckling piece and the buckling groove are in buckled fit with each other, such that the end portion of the first neck-surrounding part and the end portion of the second neck-surrounding part are detachably fixed to each other, the first neck-surrounding part and the second neck-surrounding part bend away from each other, and a neck-hanging space is formed by enclosing the first neck-surrounding part and the second neck-surrounding part.

In some optional implementations, the buckling piece includes a buckling block, an elastic member and a button, the end portion of the first neck-surrounding part is provided with a first cavity, and the buckling block and the elastic member are arranged inside the first cavity; the button is connected to the buckling block and movably extends to outside of the first cavity; and the buckling block is in buckled fit with the buckling groove; and

the button presses the first cavity inward to drive the buckling block to move, such that the buckling block is detached from the buckling groove, and the elastic member is compressed and deformed.

In some optional implementations, the buckling block is provided with a protruding limiting portion, and a limiting groove is formed in the buckling groove, where the limiting portion extends into the limiting groove to achieve the buckled fit between the buckling block and the buckling groove.

In some optional implementations, the end portion of the first neck-surrounding part is provided with a positioning groove, and the buckling block extends into the positioning groove; the end portion of the second neck-surrounding part is provided with a protruding positioning portion, and the positioning groove is arranged on the positioning portion; and the positioning groove and the positioning portion are in positioning fit with each other.

In some optional implementations, the end portion of the first neck-surrounding part is provided with the first cavity, and the first magnetic element is arranged in the first cavity.

In some optional implementations, the end portion of the first neck-surrounding part is provided with a plurality of first magnetic elements, and the plurality of first magnetic elements are arranged around the buckling piece; the end portion of the second neck-surrounding part is provided with a plurality of second magnetic elements, and the plurality of second magnetic elements are arranged around the buckling groove; and the first magnetic elements and the second magnetic elements are in corresponding magnetic fit with each other.

In some optional implementations, the end portion of the second neck-surrounding part is provided with a second cavity, and the second magnetic element is arranged in the second cavity.

In some optional implementations, the equipment holder is either a holder for fixing a mobile phone or a holder for fixing a camera.

In some optional implementations, the equipment holder includes a fixed clamping structure, a plurality of damping rotating shafts, and a plurality of moving arms, where the plurality of moving arms are sequentially connected through the damping rotating shafts, one of the moving arms is connected to the assembly part through the damping rotating shaft, and the fixed clamping structure is arranged on the moving arm farthest from the assembly part.

In some optional implementations, either the first neck-surrounding part or the second neck-surrounding part includes an outer sleeve and a flexible inner supporting tube, where the outer sleeve is connected to the neck-buckling body, and the inner supporting tube is arranged in the outer sleeve; and

in the neck-hanging state, both ends of the two outer sleeves are connected with each other, and in the selfie state, both ends of the two outer sleeves are separated from each other.

In some optional implementations, either end of the inner supporting tube is provided with a fixing structure, and two ends of the inner supporting tube, through the fixing structures, are fixed to a tail end of the outer sleeve and the neck-buckling body respectively.

In some optional implementations, either of the fixing structures includes a connector and a limiting member, the connectors of two fixing structures are installed at both ends of the inner supporting tube, and the limiting members are arranged on the corresponding connectors respectively; and the limiting members at both ends of the inner supporting tube are detachably connected to the tail end of the corresponding outer sleeve and the neck-buckling body respectively to limit positions of the connectors.

In some optional implementations, the limiting members are bolts that are in threaded fit with the connectors, a fixing base is arranged at the tail end of the outer sleeve, and the bolts at both ends of the inner supporting tube are in threaded fit with the fixing base and the neck-buckling body respectively in a corresponding manner.

In some optional implementations, the outer sleeve is made of silicone or soft plastic, and the inner supporting tube is a flexible metal hose.

In some optional implementations, the end portion of the first neck-surrounding part and/or the end portion of the second neck-surrounding part is provided with a protruding holding portion.

Compared with the prior art, the neck-hanging selfie photography support device of the present disclosure is capable of switching between the neck-hanging state and the selfie state, and better meeting users' photography needs. The neck-hanging selfie photography support device has a simple structure, facilitates operation, and offers a good user experience. To wear as needed, a user only needs to adjust the first neck-surrounding part and the second neck-surrounding part around the back of his/her neck, and then connects the first neck-surrounding part and the second neck-surrounding part through the magnetic attraction structure and the buckle structure, to complete quick and easy wearing. Due to the combination of the magnetic attraction structure and the buckle structure, the first neck-surrounding part and the second neck-surrounding part are connected securely and not easily disengaged from each other. Further, when not in use, the first neck-surrounding part and the second neck-surrounding part can be separated for easy carrying and storage.

To further clarify and understand the present disclosure, specific implementations of the present disclosure will be described in detail with reference to the accompanying drawings.

### BRIEF DESCRIPTION OF THE DRAWINGS

FIG. 1 is a structural schematic diagram of a neck-hanging selfie photography support device according to an embodiment of the present disclosure.

FIG. 2 is a structural schematic diagram of a side of a neck-hanging selfie photography support device according to an embodiment of the present disclosure.

FIG. 3 is a partial exploded view of a neck-hanging selfie photography support device according to an embodiment of the present disclosure.

FIG. 4 is a structural schematic diagram of a neck-hanging selfie photography support device in a neck-hanging state according to an embodiment of the present disclosure.

FIG. 5 is a structural schematic diagram of a neck-hanging selfie photography support device in a selfie state according to an embodiment of the present disclosure.

FIG. 6 is a structural schematic diagram of a neck-hanging selfie photography support device in a neck-hanging state and a selfie state according to an embodiment of the present disclosure.

FIG. 7 is a structural schematic diagram of a buckling piece according to an embodiment of the present disclosure.

FIG. 8 is a first exploded view of a neck-hanging selfie photography support device according to an embodiment of the present disclosure.

FIG. 9 is a second exploded view of a neck-hanging selfie photography support device according to an embodiment of the present disclosure.

FIG. 10 is a sectional view of a neck-hanging selfie photography support device according to an embodiment of the present disclosure.

FIG. 11 is an enlarged view of a portion A illustrated in FIG. 10.

FIG. 12 is an enlarged view of a portion B illustrated in FIG. 9.

FIG. 13 is an enlarged view of a portion C illustrated in FIG. 9.

### DESCRIPTION OF REFERENCE NUMERALS

10. neck-buckling body; 20. equipment holder; 21. fixed clamping structure; 22. damping rotating shaft; 23. moving arm; 30. first neck-surrounding part; 31. first magnetic element; 32. buckling piece; 321. buckling block; 3211. limiting portion; 322. elastic member; 323. button; 33. first cavity; 34. positioning groove; 35. outer sleeve; 36. inner supporting tube; 37. fixing structure; 371. connector; 372. limiting member; 38. fixing base; 39. holding portion; 40. second neck-surrounding part; 41. second magnetic element; 42. buckling groove; 43. limiting groove; 44. positioning portion; 45. second cavity; 50. neck-hanging space; and 60. support rod structure.

### DETAILED DESCRIPTIONS OF THE EMBODIMENTS

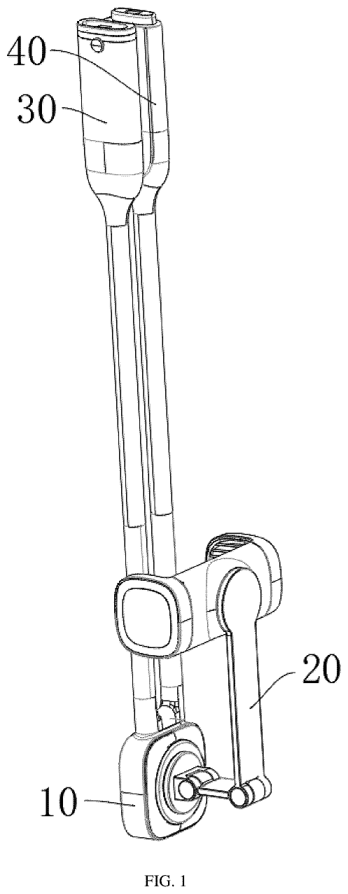

The technical solutions in the embodiments of the present disclosure will be clearly and completely described below with reference to the accompanying drawings in the embodiments of the present disclosure. With reference to FIG. 1, in an embodiment of the present disclosure, there is provided a neck-hanging selfie photography support device, and the neck-hanging selfie photography support device includes a neck-buckling body 10.

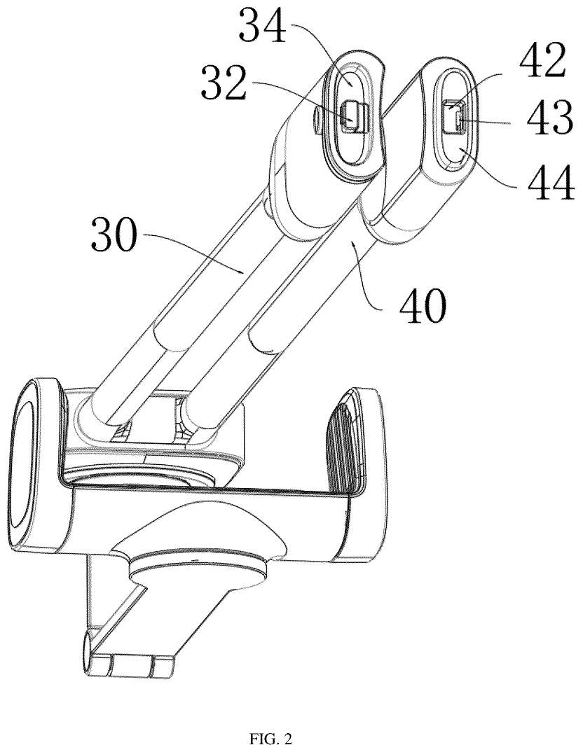

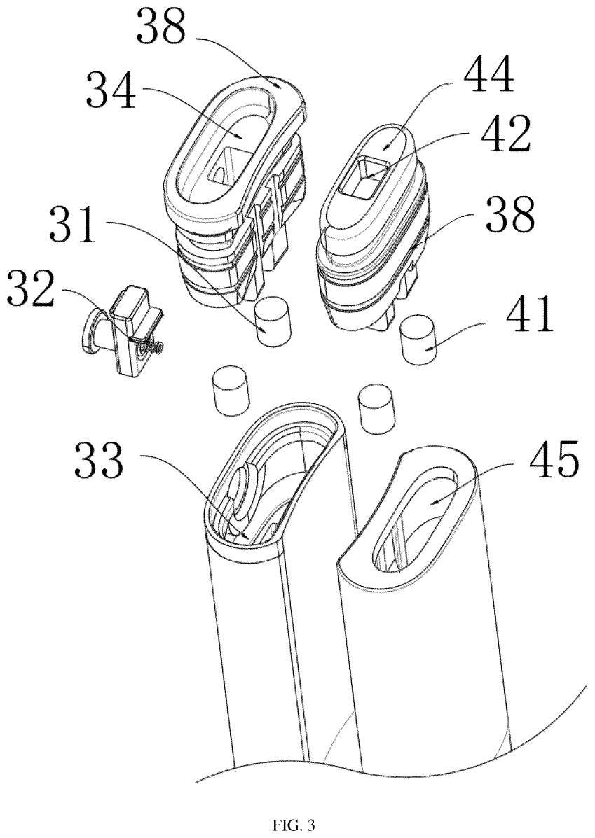

With reference to FIGS. 2 and 3, an equipment holder 20, a flexible first neck-surrounding part 30 and a flexible second neck-surrounding part 40 are arranged on the neck-buckling body 10. In this embodiment, an end portion of the first neck-surrounding part 30 is provided with a first magnetic element 31 and a buckling piece 32, and an end portion of the second neck-surrounding part 40 is provided with a second magnetic element 41 and a buckling groove 42, which is taken as an example for explanation. Of course, in a neck-hanging state, the end portion of the first neck-surrounding part 30 can be detachably connected to the end portion of the second neck-surrounding part 40 only through a magnetic attraction structure or a buckle structure. For the magnetic attraction structure, reference can be made to a combination of the first magnetic element 31 and the second magnetic element 41; and for the buckle structure, reference can be made to a combination of the buckling piece 32 and the buckling groove 42, but the implementation of the present disclosure is not limited to this example.

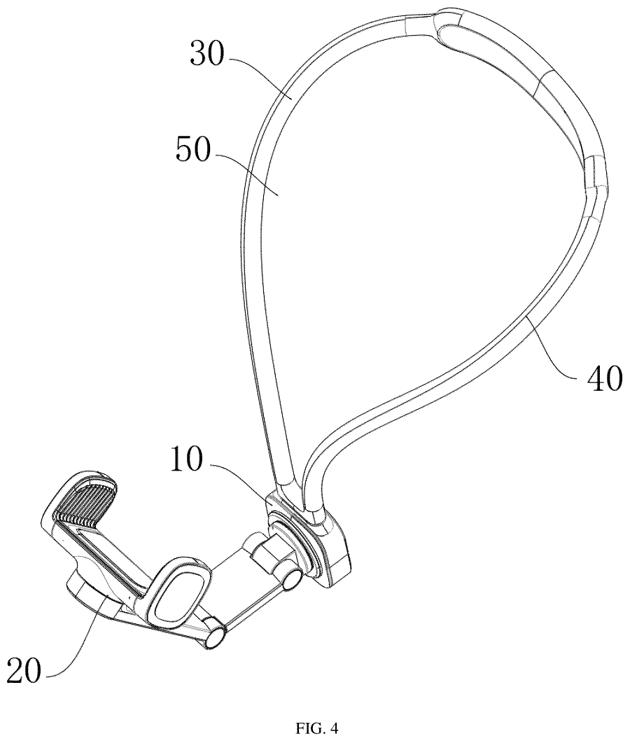

With reference to FIG. 4, in the neck-hanging state, the first magnetic element 31 and the second magnetic element 41 match each other in a magnetic manner, and the buckling piece 32 and the buckling groove 42 are in buckled fit with each other, such that the end portion of the first neck-surrounding part 30 and the end portion of the second neck-surrounding part 40 are detachably fixed to each other, the first neck-surrounding part 30 and the second neck-surrounding part 40 bend away from each other, and a neck-hanging space 50 is formed by enclosing the first neck-surrounding part 30 and the second neck-surrounding part 40.

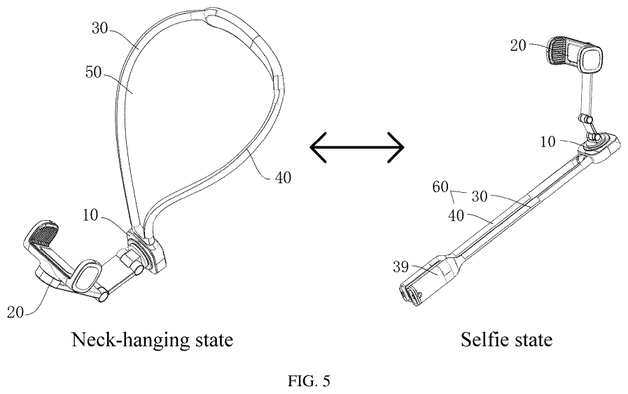

With reference to FIG. 5, in a selfie state, the end portion of the first neck-surrounding part 30 and the end portion of the second neck-surrounding part 40 are separated from each other, the first neck-surrounding part 30 and the second neck-surrounding part 40 bend towards each other until the first neck-surrounding part 30 and the second neck-surrounding part 40 are arranged side by side, and the first neck-surrounding part 30 and the second neck-surrounding part 40 collectively form a support rod structure 60.

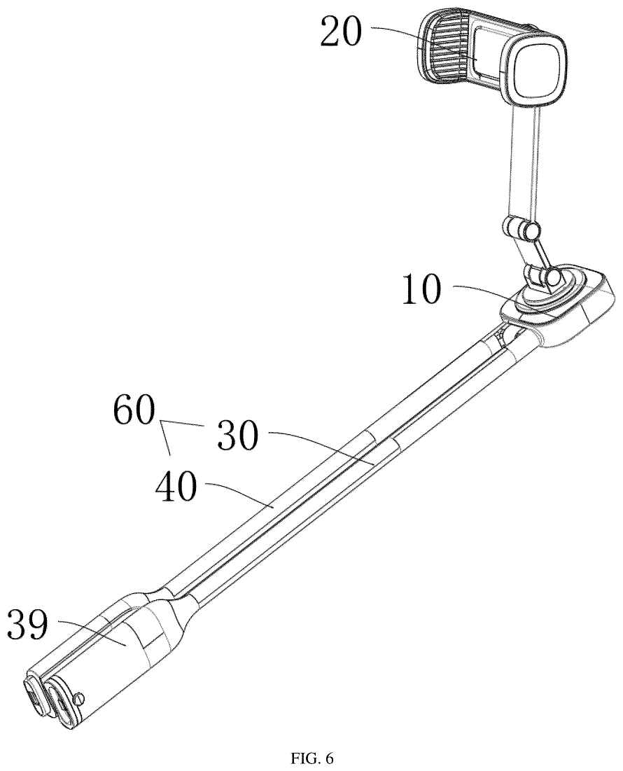

With reference to FIG. 6, to wear as needed, a user needs to switch the neck-hanging selfie photography support device to the neck-hanging state, only needs to adjust the first neck-surrounding part 30 and the second neck-surrounding part 40 around the back of his/her neck, and then initially connects the first neck-surrounding part 30 and the second neck-surrounding part 40 through the first magnetic element 31 and the second magnetic element 41. The buckling piece 32 and the buckling groove 42 are in buckled fit with each other to achieve a more stable connection, such that the first neck-surrounding part 30 and the second neck-surrounding part 40 are connected securely and not easily disengaged from each other. Further, although the end portion of the first neck-surrounding part 30 and the end portion of the second neck-surrounding part 40 are out of sight when the user adjusts them around the back of his/her neck, the first magnetic element 31 and the second magnetic element 41 are capable of guiding the first neck-surrounding part 30 and the second neck-surrounding part 40 to move towards each other, such that the user can align the buckling piece 32 with the buckling groove 42 more conveniently. When not in use, the first neck-surrounding part 30 and the second neck-surrounding part 40 can be separated for easy carrying and storage. To take a selfie as needed, the neck-hanging selfie photography support device is switched to the selfie state first, the end portion of the first neck-surrounding part 30 and the end portion of the second neck-surrounding part 40 are separated from each other, the first neck-surrounding part 30 and the second neck-surrounding part 40 bend towards each other until the first neck-surrounding part 30 and the second neck-surrounding part 40 are arranged side by side, and the first neck-surrounding part 30 and the second neck-surrounding part 40 collectively form the support rod structure 60. The user, by holding one end of the support rod structure 60 away from the neck-buckling body 10, can extend the neck-buckling body 10, such that the equipment holder 20 is away from the user, and a sufficient predetermined distance between the user and photographic equipment on the equipment holder 20 can be maintained for taking selfies. The present disclosure has a simple overall structure and facilitates operation. Further, it should be noted that to take a desired selfie, the user can straighten or bend the first neck-surrounding part 30 and the second neck-surrounding part 40 as needed according to the required predetermined distance for taking selfies.

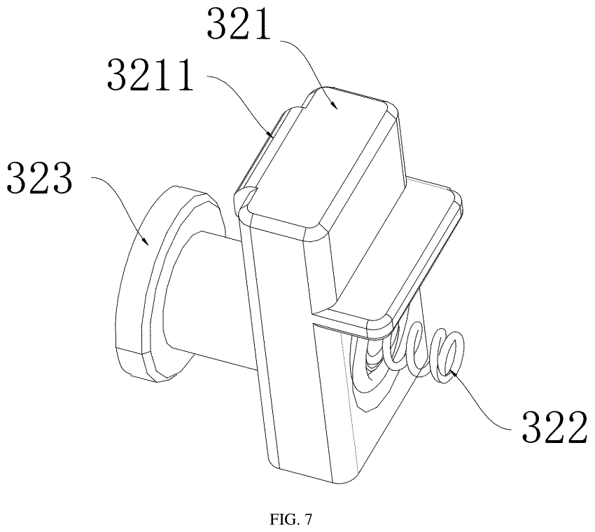

With reference to FIG. 7, a structure of the buckling piece 32 can be designed according to practical needs. For example, in some optional implementations, the buckling piece 32 includes a buckling block 321, an elastic member 322 and a button 323. The end portion of the first neck-surrounding part 30 is provided with a first cavity 33, and the buckling block 321 and the elastic member 322 are arranged inside the first cavity 33. The button 323 is connected to the buckling block 321 and movably extends to outside of the first cavity 33. The buckling block 321 is in buckled fit with the buckling groove 42. The button 323 presses the first cavity 33 inward to drive the buckling block 321 to move, such that the buckling block 321 is detached from the buckling groove 42, and the elastic member 322 is compressed and deformed. In this case, the user can apply a sufficient force to the first neck-surrounding part 30 and the second neck-surrounding part 40 to overcome a magnetic force between the first magnetic element 31 and the second magnetic element 41, such that the first neck-surrounding part 30 and the second neck-surrounding part 40 are separated from each other. When the user releases the button 323, the elastic member 322 drives the button 323 back to its original position.

The elastic member 322 can have an elastic structure such as a spring or an elastic sheet.

To facilitate the buckled fit between the buckling block 321 and the buckling groove 42, in some optional implementations, the buckling block 321 is provided with a protruding limiting portion 3211, and a limiting groove 43 is formed in the buckling groove 42, where the limiting portion 3211 extends into the limiting groove 43 to achieve the buckled fit between the buckling block 321 and the buckling groove 42.

In some optional implementations, the end portion of the first neck-surrounding part 30 is provided with a positioning groove 34, and the buckling block 321 extends into the positioning groove 34. The end portion of the second neck-surrounding part 40 is provided with a protruding positioning portion 44, and the positioning groove 34 is arranged on the positioning portion 44. The positioning groove 34 and the positioning portion 44 are in positioning fit with each other, thereby enhancing the stability of connection between the first neck-surrounding part 30 and the second neck-surrounding part 40 and preventing the first neck-surrounding part 30 and the second neck-surrounding part 40 from shaking against each other.

In some optional implementations, the end portion of the first neck-surrounding part 30 is provided with the first cavity 33, and the first magnetic element 31 is arranged in the first cavity 33 to better protect the first magnetic element 31.

In some optional implementations, the end portion of the first neck-surrounding part 30 is provided with a plurality of first magnetic elements 31, and the plurality of first magnetic elements 31 are arranged around the buckling piece 32. The end portion of the second neck-surrounding part 40 is provided with a plurality of second magnetic elements 41, and the plurality of second magnetic elements 41 are arranged around the buckling groove 42. The first magnetic elements 31 and the second magnetic elements 41 are in corresponding magnetic fit with each other, thereby enhancing the stability of the magnetic connection between the first neck-surrounding part 30 and the second neck-surrounding part 40, and making it easier to guide the buckling piece 32 to connect with the buckling groove 42.

In some optional implementations, the end portion of the second neck-surrounding part 40 is provided with a second cavity 45, and the second magnetic element 41 is arranged in the second cavity 45 to better protect the second magnetic element 41.

At least one of the first magnetic element 31 and the second magnetic element 41 is a magnet, and the other one is either a magnet or an iron piece.

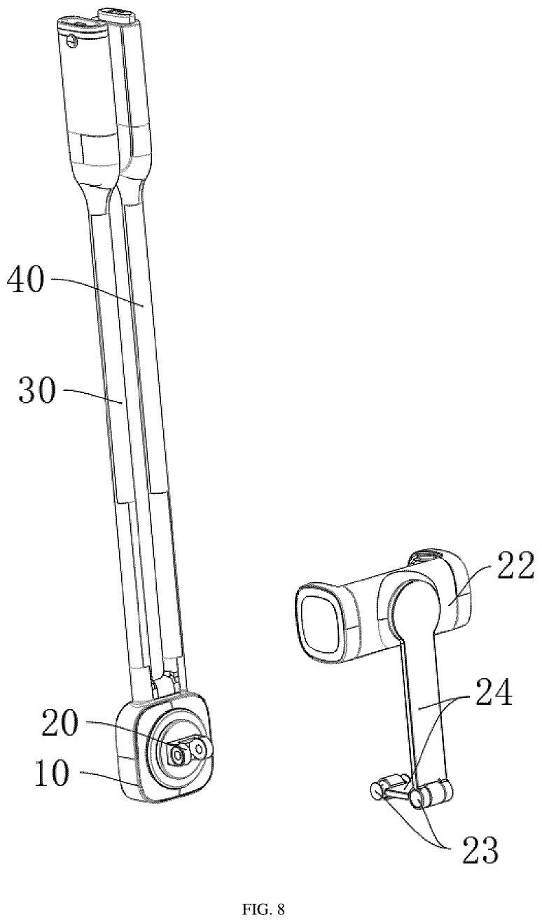

With reference to FIG. 8, the equipment holder 20 can be selected by the user according to actual application scenarios and needs, to ensure that the holder is capable of fixing suitable photographic equipment. For example, in some optional implementations, the equipment holder 20 is either a holder for fixing a mobile phone or a holder for fixing a camera. Of course, the equipment holder 20 can also be of any other type, and is not limited to fixing a mobile phone or a camera.

In some optional implementations, the equipment holder 20 includes a fixed clamping structure 21, a plurality of damping rotating shafts 22, and a plurality of moving arms 23, where the plurality of moving arms 23 are sequentially connected through the damping rotating shafts 22. One of the moving arms 23 is connected to an assembly part through one corresponding damping rotating shaft 22, and the fixed clamping structure 21 is arranged on the moving arm 23 farthest from the assembly part.

The fixed clamping structure 21 is configured for fixing photographic equipment such as a mobile phone or a camera, and the damping rotating shafts 22 facilitate the adjustment of angles between the moving arms 23, such that the photographic equipment is capable of maintaining an appropriate angle for shooting.

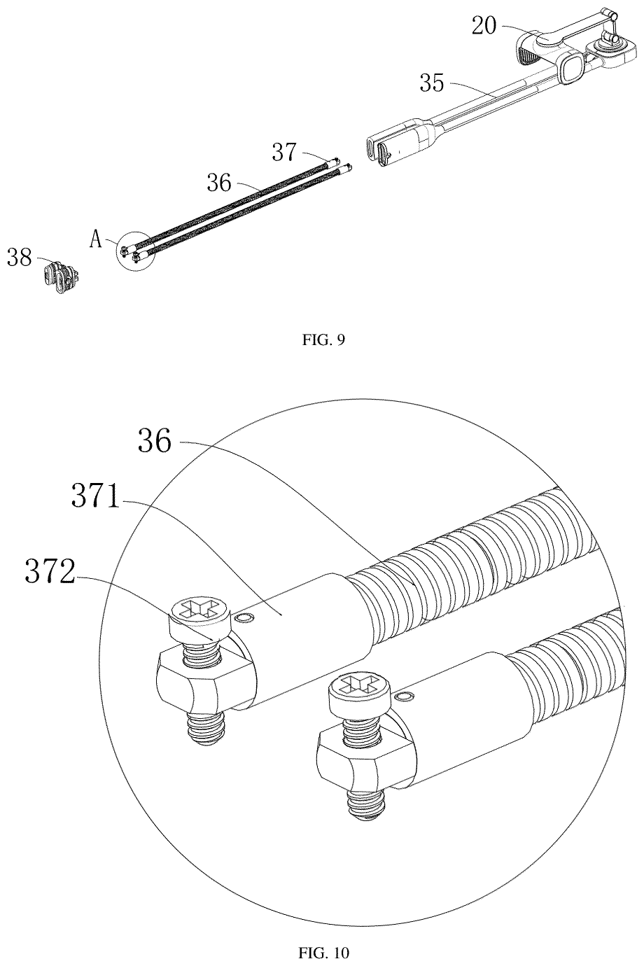

With reference to FIG. 9, specific structures of the first neck-surrounding part 30 and the second neck-surrounding part 40 can be properly designed according to practical needs. For example, in some optional implementations, either the first neck-surrounding part 30 or the second neck-surrounding part 40 includes an outer sleeve 35 and a flexible inner supporting tube 36, where the outer sleeve 35 is connected to the neck-buckling body 10, and the inner supporting tube 36 is arranged in the outer sleeve 35. In the neck-hanging state, both ends of the two outer sleeves 35 are connected with each other, and in the selfie state, both ends of the two outer sleeves 35 are separated from each other. Of course, flexible plastic tubes can also be directly used as the first neck-surrounding part 30 and the second neck-surrounding part 40, but the implementation of the present disclosure is not limited to this example.

In some optional implementations, either end of the inner supporting tube 36 is provided with a fixing structure 37, and two ends of the inner supporting tube 36, through the fixing structures 37, are fixed to a tail end of the outer sleeve 35 and the neck-buckling body 10 respectively, to ensure that the inner supporting tube 36 and the outer sleeve 35 keep stable and do not slide relative to each other, so as to achieve fast and convenient installation of the inner supporting tube 36.

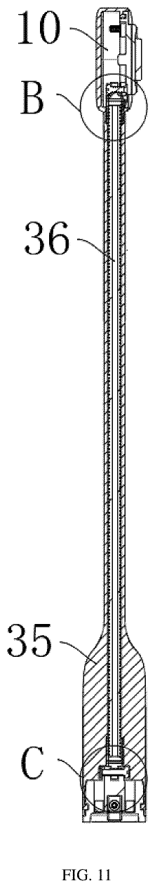

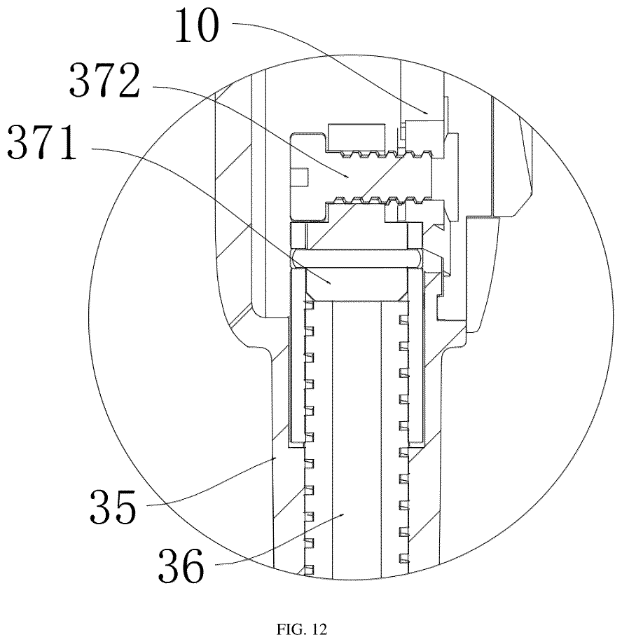

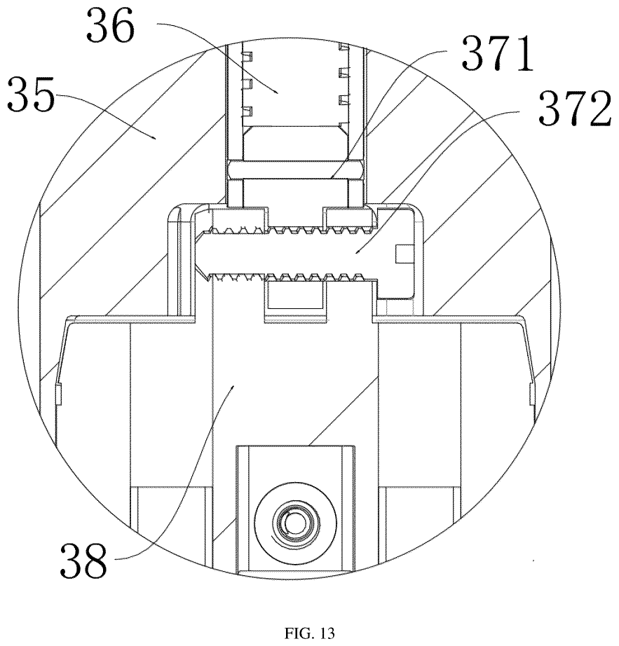

With reference to FIGS. 10-13, in some optional implementations, either of the fixing structures 37 includes a connector 371 and a limiting member 372. The connectors 371 of two fixing structures 37 are installed at both ends of the inner supporting tube 36, and the limiting members 372 are arranged on the corresponding connectors 371 respectively. The limiting members 372 at both ends of the inner supporting tube 36 are detachably connected to the tail end of the corresponding outer sleeve 35 and the neck-buckling body 10 respectively to limit positions of the connectors 371. The connectors 371 at both ends of the inner supporting tube 36 cannot move toward a middle of the outer sleeve 35 due to limitation by the limiting members 372, thereby ensuring that the inner supporting tube 36 remains taut relative to the outer sleeve 35, and the outer sleeve 35 can be well supported by the inner supporting tube 36 to form different degrees of curvature. In this implementation, the first cavity 33 is formed in an end portion of the outer sleeve 35 of the first neck-surrounding part 30, and the second cavity 45 is formed in an end portion of the outer sleeve 35 of the second neck-surrounding part 40.

In some optional implementations, the limiting members 372 are bolts that are in threaded fit with the connectors 371. A fixing base 38 is arranged at the tail end of the outer sleeve 35, and the bolts at both ends of the inner supporting tube 36 are in threaded fit with the fixing base 38 and the neck-buckling body 10 respectively in a corresponding manner. Use of the bolts facilitates the quick assembly and disassembly of the connectors 371, the fixing base 38 and the neck-buckling body 10. Of course, the limiting members 372 can also have other suitable structures such as inserting pins and the buckling piece 32, which are not limited to bolts. In this implementation, the neck-buckling body 10 actually further includes an outer housing and an inner housing, where the outer housing is integrated with the outer sleeve 35, and the inner housing is configured for supporting the outer housing. The connectors 371 can be in threaded fit with the inner housing through bolts. In this implementation, compared to the soft and flexible outer sleeve 35, the fixing base 38 is harder, the fixing base 38 on the first neck-surrounding part 30 is arranged in the first cavity 33, and the buckling piece 32 and the first magnetic element 31 are arranged on the fixing base 38 of the first neck-surrounding part 30, thereby facilitating the stable fixation of the buckling piece 32 and the first magnetic element 31. The fixing base 38 on the second neck-surrounding part 40 is arranged in the second cavity 45, and the buckling groove 42 and the second magnetic element 41 are arranged on the fixing base 38 of the second neck-surrounding part 40, thereby facilitating the stable fixation of the second magnetic element 41 and preventing deformation of the buckling groove 42.

In some optional implementations, the outer sleeve 35 is made of silicone or soft plastic, which enhances comfort of the user and facilitates the design in appearance and color. The inner supporting tube 36 is a flexible metal hose that is capable of maintaining different degrees of curvature well and has a long service life.

In the neck-hanging state, the first neck-surrounding part 30 and the second neck-surrounding part 40 need to be hung on both sides of the user′ neck, and their thickness needs to be controlled within an appropriate range, that is, they cannot be too thick or large, to prevent affecting the user's neck-hanging experience. However, when the first neck-surrounding part 30 and the second neck-surrounding part 40 are too thin, the user hardly can securely hold the support rod structure 60 formed by the first neck-surrounding part 30 and the second neck-surrounding part 40. Therefore, in some optional implementations, the end portion of the first neck-surrounding part 30 and/or the end portion of the second neck-surrounding part 40 is provided with a protruding holding portion 39. The holding portion 39 only increases the thickness of the end portion of the first neck-surrounding part 30 and/or the end portion of the second neck-surrounding part 40, having minimal impact on the neck-hanging experience.

Further, the holding portion 39 of the first neck-surrounding part 30 and/or the second neck-surrounding part 40 is capable of enlarging a partial position of the first neck-surrounding part 30 and/or the second neck-surrounding part 40, such that the user can securely grasp the two holding portions 39, and the support rod structure 60 is unlikely to release from the user's hands.

In this implementation, since the holding portion 39 enlarges the thickness of the end portion of the first neck-surrounding part 30 and/or the end portion of the second neck-surrounding part 40, the first cavity 33 can be arranged in the holding portion 39 at the end portion of the first neck-surrounding part 30, thus facilitating the expansion of an internal volume of the first cavity 33 to accommodate more structures, such as the bolts, the first magnetic element 31, the buckling piece 32, and the like. Similarly, the second cavity 45 can be arranged in the holding portion 39 at the end portion of the second neck-surrounding part 40, thus facilitating the expansion of an internal volume of the second cavity 45 to accommodate more structures, such as the bolts, the second magnetic element 41, the buckling groove 42, and the like.

Although the embodiments of the present invention have been shown and described, it should be understood that those of ordinary skill in the art may make various changes, modifications, replacements, and variations to these embodiments without departing from the principle and spirit of the present invention, and the scope of the present invention is limited by the appended claims and their equivalents.

What is claimed is:

1. A neck-hanging selfie photography support device, comprising a neck-buckling body;
an equipment holder, a flexible first neck-surrounding part and a flexible second neck-surrounding part are arranged on the neck-buckling body;
in a neck-hanging state, an end portion of the first neck-surrounding part and an end portion of the second neck-surrounding part are detachably fixed through a buckle structure or a magnetic attraction structure, the first neck-surrounding part and the second neck-surrounding part bend away from each other, and a neck-hanging space is formed by enclosing the first neck-surrounding part and the second neck-surrounding part; and
in a selfie state, the end portion of the first neck-surrounding part and the end portion of the second neck-surrounding part are separated from each other, the first neck-surrounding part and the second neck-surrounding part bend towards each other until the first neck-surrounding part and the second neck-surrounding part are arranged side by side, and the first neck-surrounding part and the second neck-surrounding part collectively form a support rod structure.

2. The neck-hanging selfie photography support device according to claim 1, wherein an end portion of the first neck-surrounding part is provided with a first magnetic element and a buckling piece, and an end portion of the second neck-surrounding part is provided with a second magnetic element and a buckling groove; and
in the neck-hanging state, the first magnetic element and the second magnetic element match each other in a magnetic manner, and the buckling piece and the buckling groove are in buckled fit with each other, such that the end portion of the first neck-surrounding part and the end portion of the second neck-surrounding part are detachably fixed to each other, the first neck-surrounding part and the second neck-surrounding part bend away from each other, and a neck-hanging space is formed by enclosing the first neck-surrounding part and the second neck-surrounding part.

3. The neck-hanging selfie photography support device according to claim 2, wherein the buckling piece comprises a buckling block, an elastic member and a button, the end portion of the first neck-surrounding part is provided with a first cavity, and the buckling block and the elastic member are arranged inside the first cavity; the button is connected to the buckling block and movably extends to outside of the first cavity; and the buckling block is in buckled fit with the buckling groove; and
the button presses the first cavity inward to drive the buckling block to move, such that the buckling block is detached from the buckling groove, and the elastic member is compressed and deformed.

4. The neck-hanging selfie photography support device according to claim 3, wherein the buckling block is provided with a protruding limiting portion, and a limiting groove is formed in the buckling groove, wherein the limiting portion extends into the limiting groove to achieve the buckled fit between the buckling block and the buckling groove.

5. The neck-hanging selfie photography support device according to claim 3, wherein the end portion of the first neck-surrounding part is provided with a positioning groove, and the buckling block extends into the positioning groove; the end portion of the second neck-surrounding part is provided with a protruding positioning portion, and the positioning groove is arranged on the positioning portion; and the positioning groove and the positioning portion are in positioning fit with each other.

6. The neck-hanging selfie photography support device according to claim 2, wherein the end portion of the first neck-surrounding part is provided with the first cavity, and the first magnetic element is arranged in the first cavity.

7. The neck-hanging selfie photography support device according to claim 2, wherein the end portion of the first neck-surrounding part is provided with a plurality of first magnetic elements, and the plurality of first magnetic elements are arranged around the buckling piece; the end portion of the second neck-surrounding part is provided with a plurality of second magnetic elements, and the plurality of second magnetic elements are arranged around the buckling groove; and the first magnetic elements and the second magnetic elements are in corresponding magnetic fit with each other.

8. The neck-hanging selfie photography support device according to claim 2, wherein the end portion of the second neck-surrounding part is provided with a second cavity, and the second magnetic element is arranged in the second cavity.

9. The neck-hanging selfie photography support device according to claim 1, wherein the equipment holder is either a holder for fixing a mobile phone or a holder for fixing a camera.

10. The neck-hanging selfie photography support device according to claim 1, wherein the equipment holder comprises a fixed clamping structure, a plurality of damping rotating shafts, and a plurality of moving arms, wherein the plurality of moving arms are sequentially connected through the damping rotating shafts, one of the moving arms is connected to the assembly part through the damping rotating shaft, and the fixed clamping structure is arranged on the moving arm farthest from the assembly part.

11. The neck-hanging selfie photography support device according to claim 1, wherein either the first neck-surrounding part or the second neck-surrounding part comprises an outer sleeve and a flexible inner supporting tube, wherein the outer sleeve is connected to the neck-buckling body, and the inner supporting tube is arranged in the outer sleeve; and
in the neck-hanging state, both ends of the two outer sleeves are connected with each other, and in the selfie state, both ends of the two outer sleeves are separated from each other.

12. The neck-hanging selfie photography support device according to claim 11, wherein either end of the inner supporting tube is provided with a fixing structure, and two ends of the inner supporting tube, through the fixing structures, are fixed to a tail end of the outer sleeve and the neck-buckling body respectively.

13. The neck-hanging selfie photography support device according to claim 12, wherein either of the fixing structures comprises a connector and a limiting member, the connectors of two fixing structures are installed at both ends of the inner supporting tube, and the limiting members are arranged on the corresponding connectors respectively; and the limiting members at both ends of the inner supporting tube are detachably connected to the tail end of the corresponding outer sleeve and the neck-buckling body respectively to limit positions of the connectors.

14. The neck-hanging selfie photography support device according to claim 13, wherein the limiting members are bolts that are in threaded fit with the connectors, a fixing base is arranged at the tail end of the outer sleeve, and the bolts at both ends of the inner supporting tube are in threaded fit with the fixing base and the neck-buckling body respectively in a corresponding manner.

15. The neck-hanging selfie photography support device according to claim 11, wherein the outer sleeve is made of silicone or soft plastic, and the inner supporting tube is a flexible metal hose.

16. The neck-hanging selfie photography support device according to claim 1, wherein the end portion of the first neck-surrounding part and/or the end portion of the second neck-surrounding part is provided with a protruding holding portion.
